(19) United States
(12) Patent Application Publication
(10) Pub. No.: US 2009/0256922 A1
(43) Pub. Date: Oct. 15, 2009

(54) DEVICE, METHOD AND SYSTEM OF WIRELESS VIDEO COMMUNICATION

(76) Inventors: Eylon Gersten, Even Yehuda (IL); Netanel Goldberg, Zichron Yaakov (IL); Oren Goldshtein, Nahariya (IL)

Correspondence Address: EMPK & Shiloh, LLP;c/o Landon IP, Inc., 1700 Diagonal Road, Suite 450, Alexandria, VA, 22314, US

(21) Appl. No.: 12/100,429

(22) Filed: Apr. 10, 2008

(51) Int. Cl. H04N 5/228; H04N 5/38; H04N 5/44

(52) U.S. Cl. 348/222.1; 348/723; 348/725; 348/E05.093; 348/E05.031; 348/E05.096

(57) ABSTRACT

Some demonstrative embodiments include devices, systems and/or methods of wireless video communication. Some embodiments include a wireless video transmitter to transmit a wireless video transmission representing a video image, the transmitter including a digital-input interface including a plurality of video-data inputs to receive a respective plurality of digital-video bits representing a pixel of the video image, and one or more synchronization inputs to receive one or more respective synchronization signals corresponding to the video image; and a transmitter module to transmit the wireless video transmission based on the plurality of digital-video bits and the synchronization signals. Other embodiments are described and claimed.

### FIELD

Some embodiments relate generally to the filed of wireless communication and, more particularly, to wireless communication including video information.

### BACKGROUND

Wireless communication has rapidly evolved over the past decades. Even today, when high performance and high bandwidth wireless communication equipment is made available there is demand for even higher performance at a higher data rates, which may be required by more demanding applications.

Video signals may be generated by various video sources, for example, a computer, a game console, a Video Cassette Recorder (VCR), a Digital-Versatile-Disc (DVD), or any other suitable video source. In many houses, for example, video signals are received through cable or satellite links at a Set-Top Box (STB) located at a fixed point.

In many cases, it may be desired to place a display, screen or projector at a location in a distance of at least a few meters from the video source. This trend is becoming more common as flat-screen displays, e.g., plasma or Liquid Crystal Display (LCD) televisions are hung on a wall. Connection of such a display or projector to the video source through cables is generally undesired for aesthetic reasons and/or installation convenience. Thus, wireless transmission of the video signals from the video source to the screen is preferred.

### SUMMARY

Some demonstrative embodiments include systems and/or methods of wireless video communication.

Some embodiments include a wireless video transmitter to transmit a wireless video transmission representing a video image, the transmitter including a digital-input interface including a plurality of video-data inputs to receive a respective plurality of digital-video bits representing a pixel of the video image, and one or more synchronization inputs to receive one or more respective synchronization signals corresponding to the video image; and a transmitter module to transmit the wireless video transmission based on the plurality of digital-video bits and the synchronization signals.

In some embodiments, the input interface includes one or more power inputs to receive electric power to power the transmitter module.

In some embodiments, the input interface includes a shielded input interface, wherein the one or more power inputs include a plurality of power-voltage inputs grouped together at a first section of the input interface, and wherein the plurality of video-data inputs are grouped together at a second section of the input interface.

In some embodiments, the input interface includes an unshielded input interface, wherein the plurality of video-data inputs are grouped together at a section of the input interface, and wherein adjacent video-data inputs are separated from one another by a ground connector or a power-voltage connector.

In some embodiments, the plurality of video-data inputs include at least thirty video-data inputs to receive at least thirty respective digital-video bits representing a pixel of the video image.

In some embodiments, the one or more synchronization inputs include at least one of a data-enable input to receive a data-enable signal corresponding to the video image, a horizontal-synchronization input to receive a horizontal-synchronization signal corresponding to the video image, and a vertical-synchronization input to receive a vertical-synchronization signal corresponding to the video image.

In some embodiments, the input interface includes at least one clock input to receive a clock signal corresponding to the video image.

In some embodiments, the interface may include at least one ground connector adjacent to the clock input.

In some embodiments, the at least one clock input includes a data-clock input to receive a data-clock signal.

In some embodiments, the input interface includes one or more audio inputs to receive one or more digital audio signals.

Some embodiments include a video source including a video generator to generate video data to be displayed; and a digital-output interface including a plurality of video-data outputs to provide a respective plurality of digital-video bits representing a pixel of a video image of the video data, and one or more synchronization outputs to output one or more respective synchronization signals corresponding to the video image.

In some embodiments, the output interface includes one or more power outputs to output electric power to power a transmitter module.

In some embodiments, the output interface includes a shielded output interface, wherein the one or more power outputs include a plurality of power-voltage outputs grouped together at a first section of the output interface, and wherein the plurality of video-data outputs are grouped together at a second section of the output interface.

In some embodiments, the output interface includes an unshielded output interface, wherein the plurality of video-data outputs are grouped together at a section of the output interface, and wherein adjacent video-data inputs are separated from one another by a ground connector or a power-voltage connector.

In some embodiments, the plurality of video-data outputs include at least thirty video-data outputs to provide at least thirty respective digital-video bits representing a pixel of the video image.

In some embodiments, the one or more synchronization outputs include at least one of a data-enable output to output a data-enable signal corresponding to the video image, a horizontal-synchronization output to output a horizontal-synchronization signal corresponding to the video image, and a vertical-synchronization output to output a vertical-synchronization signal corresponding to the video image.

In some embodiments, the output interface includes at least one clock output to output a clock signal corresponding to the video image.

In some embodiments, the output interface includes at least one ground connector adjacent to the clock output.

In some embodiments, the output interface includes one or more audio outputs to provide one or more digital audio signals.

Some embodiments include a wireless video receiver to receive a wireless video transmission representing a video image, the wireless video receiver including a receiver module to receive the wireless video transmission and generate a plurality of digital-video bits representing a pixel of the video image, and to generate one or more synchronization signals corresponding to the video image; and a digital-output interface including a plurality of video-data outputs to output the plurality of digital-video bits, respectively; and one or more synchronization outputs to output the one or more synchronization signals, respectively.

In some embodiments, the output interface includes one or more power inputs to receive electric power to power the receiver module.

In some embodiments, the output interface includes a shielded output interface, wherein the one or more power inputs include a plurality of power-voltage inputs grouped together at a first section of the output interface, and wherein the plurality of video-data outputs are grouped together at a second section of the output interface.

In some embodiments, the output interface includes an unshielded output interface, wherein the plurality of video-data outputs are grouped together at a section of the output interface, and wherein adjacent video-data outputs are separated from one another by a ground connector or a power-voltage connector.

In some embodiments, the plurality of video-data outputs include at least thirty video-data outputs to output at least thirty respective digital-video bits representing a pixel of the video image.

In some embodiments, the one or more synchronization outputs include at least one of a data-enable output to output a data-enable signal corresponding to the video image, a horizontal-synchronization output to output a horizontal-synchronization signal corresponding to the video image, and a vertical-synchronization output to output a vertical-synchronization signal corresponding to the video image.

In some embodiments, the output interface includes at least one clock output to output a clock signal corresponding to the video image.

In some embodiments, the interface includes at least one ground connector adjacent to the clock output.

In some embodiments, the output interface includes one or more audio outputs to output one or more digital audio signals.

Some embodiments include a video destination including a digital-input interface including a plurality of video-data inputs to receive a respective plurality of digital-video bits representing a pixel of a video image, and one or more synchronization inputs to receive one or more respective synchronization signals corresponding to the video image; and a display to display the video image based on the plurality of digital-video bits.

In some embodiments, the input interface includes one or more power outputs to provide electric power to power a receiver module.

In some embodiments, the input interface includes a shielded input interface, wherein the one or more power outputs include a plurality of power-voltage outputs grouped together at a first section of the input interface, and wherein the plurality of video-data inputs are grouped together at a second section of the input interface.

In some embodiments, the input interface includes an unshielded input interface, wherein the plurality of video-data inputs are grouped together at a section of the input interface, and wherein adjacent video-data inputs are separated from one another by a ground connector or a power-voltage connector.

In some embodiments, the plurality of video-data inputs include at least thirty video-data inputs to input at least thirty respective digital-video bits representing a pixel of the video image.

In some embodiments, the one or more synchronization inputs include at least one of a data-enable input to receive a data-enable signal corresponding to the video image, a horizontal-synchronization input to receive a horizontal-synchronization signal corresponding to the video image, and a vertical-synchronization input to receive a vertical-synchronization signal corresponding to the video image.

In some embodiments, the input interface includes at least one clock input to receive a clock signal corresponding to the video image.

In some embodiments, the interface includes at least one ground connector adjacent to the clock input.

In some embodiments, the input interface includes one or more audio inputs to receive one or more digital audio signals.

Some embodiments include a connector assembly including a digital-input interface having a plurality of connectors including a plurality of video-data inputs to receive a respective plurality of digital-video bits representing a pixel of a video image, and one or more synchronization inputs to receive one or more respective synchronization signals corresponding to the video image; a digital-output interface having a plurality of connectors including a plurality of video-data outputs to output the plurality of digital-video bits, respectively; and one or more synchronization outputs to output the one or more synchronization signals, respectively; and a pair of flex cables to flexibly couple the plurality of video-data inputs to the plurality of video-data outputs, respectively, and to couple the one or more synchronization inputs to the one or more synchronization outputs, respectively.

In some embodiments, the pair of flex cables includes a first flex cable having a ground layer, and a signal layer to couple a first set of connectors of the digital-input interface to a first set of connectors of the digital-output interface, respectively; and a second flex cable having a ground layer, and a signal layer to couple a second set of connectors of the digital-input interface to a second set of connectors of the digital-output interface, respectively.

In some embodiments, the ground layer of the first flex cable faces the signal layer of the second flex cable.

In some embodiments, the input and output interfaces include at least one clock input and output, respectively, to receive and output, respectively, a clock signal corresponding to the video image.

In some embodiments, the input and output interfaces include at least one audio input and output, respectively, to receive and output, respectively, at least one digital audio signal.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. Moreover, some of the blocks depicted in the drawings may be combined into a single function. The figures are listed below.

FIG. 1 is a schematic illustration of a wireless video communication system in accordance with some demonstrative embodiments;

FIG. 2A is a schematic illustration of a shielded digital interface in accordance with some demonstrative embodiments;

FIG. 2B is a schematic illustration of an unshielded digital interface in accordance with some demonstrative embodiments;

FIG. 3 is a schematic illustration of a video source converter in accordance with some demonstrative embodiments;

FIG. 4 is a schematic illustration of a video destination converter in accordance with some demonstrative embodiments; and

FIG. 5 is a schematic illustration of a connector assembly in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments may be used in a variety of applications. Although embodiments of the invention are not limited in this respect, one or more of the methods, devices and/or systems disclosed herein may be used in many applications, e.g., civil applications, military applications or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this respect, one or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, embodiments of the invention are not limited in this respect and some embodiments may be implemented to perform wireless communication of any other suitable information, for example, multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

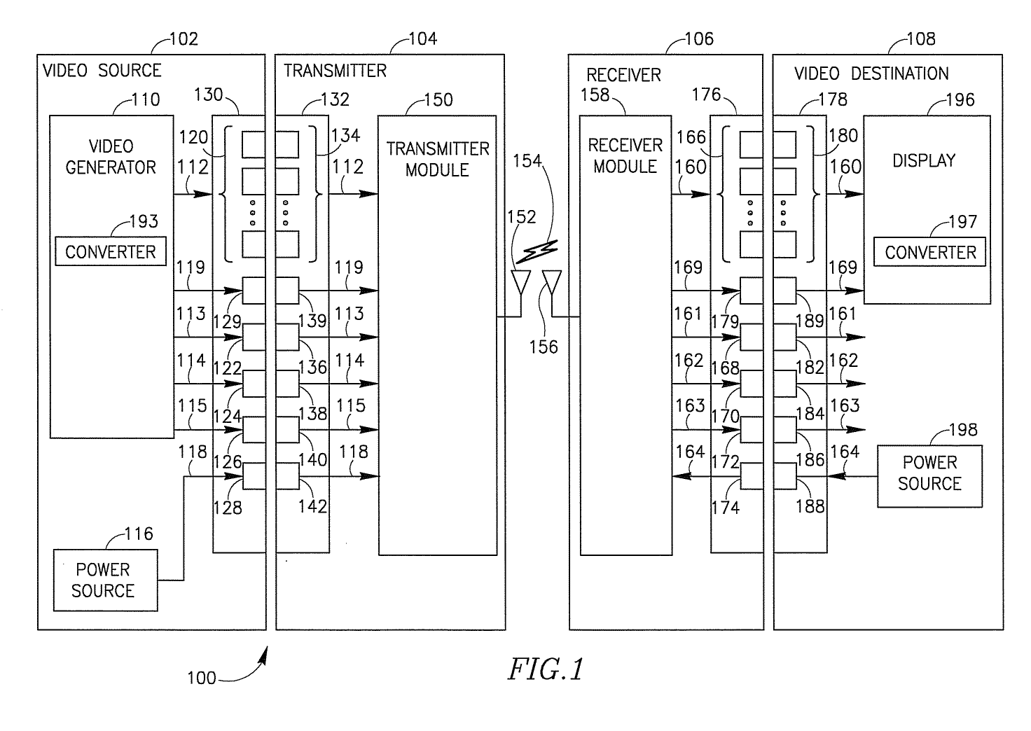

Reference is made to FIG. 1, which schematically illustrates a wireless video communication system 100, in accordance with some demonstrative embodiments.

In some demonstrative embodiments, system 100 may include a video source 102 including a video generator 110 to generate video data 112 to be displayed. Video data 112 may include, for example, a plurality of digital video signals including a respective plurality of digital-video bits representing a pixel of a video image of video data 112, e.g., as described below. Video generator 110 may also generate one or more synchronization signals 113 corresponding to the video image, e.g., as described below.

In some demonstrative embodiments, video source 102 may also include a digital-output interface 130 including a plurality of video-data outputs 120 to output the plurality of digital-video bits of video data 112, respectively, e.g., as described below. Digital-output interface 130 may also include one or more synchronization outputs 122 to output synchronization signals 113, respectively, e.g., as described below.

In some demonstrative embodiments, some or all of the components of video source 102 may be enclosed in a common housing, packaging, or the like, and may be interconnected or operably associated using one or more wired or wireless links. In other embodiments, components of video source 102 may be distributed among multiple or separate devices.

In some demonstrative embodiments, system 100 may also include a wireless video transmitter 104 to transmit a wireless video transmission 154 representing the video image of video data 112. Wireless video transmitter 104 may include a digital-input interface 132 capable of interacting with interface 130, e.g., to receive the digital-video bits and synchronization signals from interface 130. For example, interface 132 may include a plurality of video-data inputs 134 to receive from outputs 120, respectively, the plurality of digital-video bits of video data 112; and one or more synchronization inputs 136 to synchronization signals 113 from synchronization outputs 122, respectively. Wireless video transmitter 104 may also include a transmitter module 150 to transmit wireless video transmission 154, e.g., via at least one antenna 152, based on the plurality of digital-video bits received via inputs 134 and the synchronization signals 146 received via inputs 136, as described in detail below.

In some demonstrative embodiments, transmitter module 150 may implement any suitable transmission method and/or configuration to transmit transmission 154. Although embodiments of the invention are not limited in this respect, in some demonstrative embodiments, transmitter module 150 may generate transmission 154 according to an Orthogonal-Division-Frequency-Multiplexing (OFDM) modulation scheme. According to other embodiments, transmitter module 150 may generate transmission 154 according to any other suitable modulation and/or transmission scheme. In some demonstrative embodiments, transmission 154 may include a Multiple-Input-Multiple-Output (MIMO) transmission. For example, transmitter module 150 may modulate data of transmission 154 according to a suitable MIMO modulation scheme; and at least one antenna 152 may include a plurality of antennas. In one non-limiting example, at least one antenna 152 may include four transmit antennas.

Although embodiments of the invention are not limited in this respect, in some demonstrative embodiments transmitter module 150 may generate transmission 154 including at least one coarse constellation symbol representing a first component of a data value video data 112, and at least one fine constellation symbol representing a second component of the data value, for example, by applying a de-correlating transformation, e.g., a Discrete-Cosine-Transformation (DCT), to video data 112, e.g., as described in U.S. patent application Ser. No. 11/551,641, entitled “Apparatus and method for uncompressed, wireless transmission of video”, filed Oct. 20, 2006, and published May 3, 2007, as US Patent Application Publication US 2007-0098063 (“the '641 application”), the entire disclosure of which is incorporated herein by reference.

In some demonstrative embodiments, system 100 may also include a wireless video receiver 106 to receive wireless video transmission 154. Wireless video receiver 106 may include, for example, a receiver module 158 to receive wireless video transmission 154, e.g., via at least one antenna 156, to generate a plurality of digital-video bits 160 representing a pixel of the video image of transmission 154, and to generate one or more synchronization signals 161 corresponding to the video image. For example, receiver module 158 may be implemented by the wireless-video receiver described in the '641 application.

Although embodiments of the invention are not limited in this respect, types of antennae that may be used for antennas 152 and/or 156 may include but are not limited to internal antenna, dipole antenna, omni-directional antenna, a monopole antenna, an end fed antenna, a circularly polarized antenna, a micro-strip antenna, a diversity antenna and the like.

In some demonstrative embodiments, receiver module 158 may implement any suitable reception method and/or configuration to receive transmission 154. Although embodiments of the invention are not limited in this respect, in some demonstrative embodiments, receiver module 158 may receive and/or demodulate transmission 154 according to an OFDM modulation scheme. According to other embodiments, receiver module 158 may receive and/or demodulate transmission 154 according to any other suitable modulation and/or transmission scheme. In one example, transmission 154 includes a MIMO transmission, receiver module 158 may de-modulate data of transmission 154 according to a suitable MIMO modulation scheme, and at least one antenna 156 may include a plurality of antennas. In one non-limiting example, at least one antenna 156 may include five receive antennas.

In some demonstrative embodiments, wireless video receiver 106 may also include a digital-output interface 176 to output digital-video bits 160 and synchronization signals 161. For example, digital-output interface 176 may include a plurality of video-data outputs 166 to output the plurality of digital-video bits 160, respectively; and one or more synchronization outputs 168 to output one or more synchronization signals 161, respectively.

In some demonstrative embodiments, system 100 may also include a video destination 108 including a digital-input interface 178 capable of interacting with interface 176, e.g., to receive the digital-video bits and synchronization signals from interface 176. For example, digital-input interface 178 may include a plurality of video-data inputs 180 to receive the plurality of digital-video bits 160 from outputs 166, respectively; and one or more synchronization inputs 182 to receive the one or more synchronization signals 161, from synchronization outputs 168, respectively.

In some demonstrative embodiments, video destination 108 may also include a display 196 to display the video image based on the plurality of digital-video bits 160.

In some demonstrative embodiments, some or all of the components of video destination 108 may be enclosed in a common housing, packaging, or the like, and may be interconnected or operably associated using one or more wired or wireless links. In other embodiments, components of video destination 108 may be distributed among multiple or separate devices.

In some demonstrative embodiments, transmission 154 may include, for example, a HDTV video transmission or any other suitable video transmission.

In some demonstrative embodiments, video source 102 may include any suitable video device or module, for example, a portable video source, a non-portable video source, a Set-Top-Box (STB), a DVD, a digital-video-recorder, a game console, a PC, a portable computer, a Personal-Digital-Assistant (PDA), a Video Cassette Recorder (VCR), a video camera, a cellular phone, a video player, a portable-video-player, a portable DVD player, an MP-4 player, a video dongle, a cellular phone, and the like. Video destination 108 may include any suitable video display or receiver to handle the video data of digital-video bits 160. For example, video destination 108 may include a display or screen, e.g., a flat screen display, a Liquid Crystal Display (LCD), a plasma display, a back projection television, a television, a projector, a monitor, an audio/video receiver, a video dongle, and the like.

In some demonstrative embodiments, video source 102 and wireless video transmitter 104 may be implemented as part of video source device, e.g., such that video source 102 and wireless video transmitter 104 are enclosed in a common housing, packaging, or the like. In other embodiments, video source 102 and wireless video transmitter 104 may be implemented as separate devices.

In some demonstrative embodiments, video destination 108 and wireless video receiver 106 may be implemented as part of video destination device, e.g., such that video destination 108 and wireless video receiver 106 are enclosed in a common housing, packaging, or the like. In other embodiments, video destination 108 and wireless video receiver 106 may be implemented as separate devices.

In some demonstrative embodiments, interfaces 130 and 132 may include a pair of electrical connectors. For example, one of interfaces 140 and 132 may include a male electrical connector, and another of interfaces 140 and 132 may include a female electrical connector adapted to fit into the male connector. Interfaces 176 and 178 may include a pair of electrical connectors. For example, one of interfaces 176 and 178 may include a male electrical connector, and another of interfaces 176 and 178 may include a female electrical connector adapted to fit into the male connector. The male connector may include, for example, a plurality of connector pins, and the female connector may include a plurality of receptacle contacts or contact holes to receive the plurality of male connector pins, respectively.

In some demonstrative embodiments, wireless video transmitter 104 may include or may be implemented as a wireless communication card, which may be attached to video source 102. Wireless video transmitter 104 may be attached to video source 102 externally or internally. In one example, interface 130 may be internally implemented within an enclosure of video source 102, e.g., as an internal communication card slot. According to this example, wireless video transmitter 104 may be implemented as an internal wireless communication card connectable to the internal card slot, e.g., using interface 132 which may be adapted to mate with the internal card slot. In another example, interface 130 may be implemented externally to an enclosure of video source 102, e.g., as an external communication connector. The external communication connector may be implemented in addition to or instead of one or more other conventional external video connectors of video source 102, e.g., a HDMI connector, a DVI connector, a VGA connector, a XGA connector, and the like. According to this example, wireless video transmitter 104 may be implemented as an external wireless communication device connectable to the external connector, e.g., using interface 132.

In some demonstrative embodiments, wireless video receiver 106 may include or may be implemented as a wireless communication card, which may be attached to video destination 108. Wireless video receiver 106 may be attached to video destination 108 externally or internally. In one example, interface 178 may be internally implemented within an enclosure of video destination 108, e.g., as an internal communication card slot. According to this example, wireless video receiver 106 may be implemented as an internal wireless communication card connectable to the internal card slot, e.g., using interface 176 which may be adapted to mate with the internal card slot. In another example, interface 178 may be implemented externally to an enclosure of video destination 108, e.g., as an external communication connector. The external communication connector may be implemented in addition to or instead of one or more other conventional external video connectors of video destination 108, e.g., a HDMI connector, a DVI connector, a VGA connector, a XGA connector, and the like. According to this example, wireless video receiver 106 may be implemented as an external wireless communication device connectable to the external connector, e.g., using interface 176.

In some demonstrative embodiments, the number of video-data outputs 120, the number of video-data inputs 134, the number of video-data outputs 166 and/or the number of video-data inputs 180 may be equal to the number of bits implemented to represent each pixel of video data 112. In one example, video data 112 may include three-primary video data, e.g., Red-Green-Blue (RGB) data, wherein each pixel is represented by three primary color values, e.g., RGB values; YCrCb data, and/or any other suitable data format. Each of the primary color values may be represented by a plurality of bits, e.g., eight bits, ten bits, or any other suitable number of bits. The number of video-data outputs 120, the number of video-data inputs 134, the number of video-data outputs 166 and/or the number of video-data inputs 180 may be equal for example, to twenty-four if, for example, video data 112 includes 8-bit RGB data. The number of video-data outputs 120, the number of video-data inputs 134, the number of video-data outputs 166 and/or the number of video-data inputs 180 may be equal for example, to thirty if, for example, video data 112 includes 10-bit RGB data or 4:2:2 YCrCb data or any other format; equal, for example, to thirty six if, for example, video data 112 includes 12-bit RGB data or 4:4:4 YCrCb data or any other format; and/or any other suitable number, e.g., corresponding to any suitable data format of video data 112.

In some demonstrative embodiments, synchronization signals 113 may include, for example, at least one of a Horizontal Synchronization (Hsync) signal, a Vertical synchronization (Vsync) signal, a Synchronization On Green (SOG) signal, a Data Enable (DE) signal, a pixel clock signal, and/or any other suitable synchronization signal. For example, one or more synchronization outputs 122, and/or one or more synchronization outputs 168 may include at least one output to output at least one of a Hsync signal, a Vsync signal, a SOG signal, a DE signal, and a pixel clock signal, respectively, e.g., as described below. One or more synchronization inputs 136, and/or one or more synchronization inputs 182 may include at least one input to receive at least one of a Hsync signal, a Vsync signal, a SOG signal, a DE signal, and a pixel clock signal, respectively, e.g., as described below.

In some demonstrative embodiments, interfaces 130 and 132 may be capable of transferring electric power, e.g., to power transmitter module 150. For example, transmitter module 150 may be powered by electrical power 118 received from video source 102. In one example, electrical power 118 may be provided by an internal power source 116, e.g., a battery, of video source 102. In another example, electrical power 118 may be provided to video source 102 by an external power source. Interface 130 may include at least one power output 128 to output electrical power 118, and interface 132 may include at least one power input 142 to receive electrical power 118 from output 128.

In some demonstrative embodiments, interfaces 178 and 176 may be capable of transferring electric power, e.g., to power receiver module 158. For example, receiver module 158 may be powered by electrical power 164 received from video destination 108. In one example, electrical power 164 may be provided by an internal power source 198, e.g., a battery, of video destination 108. In another example, electrical power 164 may be provided to video destination 108 by an external power source. Interface 178 may include at least one power output 188 to output electrical power 164, and interface 176 may include at least one power input 174 to receive electrical power 164 from the at least one output 188, respectively.

In some demonstrative embodiments, interfaces 130 and 132 may be capable of transferring from video source 102 to wireless video transmitter 104 at least one clock signal corresponding to the video image of video data 112. For example, video generator 110 may generate at least one clock signal 114 corresponding to video data 112. Interface 130 may include at least one clock output 124 to output at least one clock signal 114, respectively. Interface 132 may include at least one clock input 138 to receive at least one clock signal 114, respectively, and provide clock signal 114 to transmitter module 150.

In some demonstrative embodiments, interfaces 176 and 178 may be capable of transferring from wireless video receiver 106 to video destination 108 at least one clock signal corresponding to the video image received via transmission 154. For example, receiver module 158 may generate at least one clock signal 162 corresponding to digital-video bits 160, e.g., based on transmission 154. Interface 176 may include at least one clock output 170 to output at least one clock signal 162, respectively. Interface 178 may include at least one clock input 184 to receive at least one clock signal 162, respectively, and provide clock signal 162 to display 196.

In some demonstrative embodiments, clock signals 114 and/or 162 may include, for example, at least one data-clock (DCLK) signal, and/or any other suitable clock signal. For example, one or more clock outputs 124, and/or one or more clock outputs 170 may include at least one clock output to output at least one DCLK signal, respectively, e.g., as described below. One or more clock inputs 138, and/or one or more clock inputs 184 may include at least one clock input to receive at least one a DCLK signal, respectively, e.g., as described below.

In some demonstrative embodiments, interfaces 130 and 132 may be capable of transferring from video source 102 to wireless video transmitter 104 at least one audio signal 115 to be transmitted as part of transmission 154. In one example, audio signal 115 may be generated by video generator 110, e.g., corresponding to video data 112. In another example, audio signal 115 may be generated by an audio source, e.g., external to video source 102. Interface 130 may include at least one audio output 126 to output at least one audio signal 115, respectively. Interface 132 may include at least one audio input 140 to receive at least one audio signal 114, respectively, and provide audio signal 114 to transmitter module 150.

In some demonstrative embodiments, interfaces 176 and 178 may be capable of transferring from wireless video receiver 106 to video destination 108 at least one audio signal received via transmission 154. For example, receiver module 158 may generate at least one audio signal 163 based on transmission 154. Interface 176 may include at least one audio output 172 to output at least one audio signal 163, respectively. Interface 178 may include at least one audio input 186 to receive at least one audio signal 163. In one example, audio signal 163 may be provided to display 196. In another example, audio signal 163 may be provided to an audio destination, e.g., external to video destination 108.

In some demonstrative embodiments, audio signals 115 and/or 163 may include, for example, any suitable audio signal, for example, a Sony/Philips Digital Interface (SPDIF) audio signal; at least one Inter-IC Sound (I²S) signal, for example, signals of a plurality, e.g., four, of I²S channels; a left-right-clock (LRCLK) audio signal; a system-clock (SCLK) audio signal; and/or any other suitable audio signal.

In some demonstrative embodiments, interfaces 130 and 132 may be capable of transferring from video source 102 to wireless video transmitter 104 at least one control signal corresponding to the video image of video data 112 and/or audio signal 115. For example, video generator 110 may generate at least one control signal 119 corresponding to video data 112. Interface 130 may include at least one control output 129 to output at least one control signal 119, respectively. Interface 132 may include at least one control input 139 to receive at least one control signal 119, respectively, and provide control signal 119 to transmitter module 150.

In some demonstrative embodiments, interfaces 176 and 178 may be capable of transferring from wireless video receiver 106 to video destination 108 at least one control signal received via transmission 154. For example, receiver module 158 may generate at least one control signal 169 based on transmission 154. Interface 176 may include at least one control output 179 to output at least one control signal 169, respectively. Interface 178 may include at least one control input 186 to receive at least one control signal 169. In one example, control signal 169 may be provided to display 196. In another example, control signal 169 may be provided to the audio destination.

In some demonstrative embodiments, control signals 119 and/or 169 may include, for example, at least one of a video reset signal (“RESET”), a serial clock (SCL) signal, a video interrupt signal (“INT”), a serial data (SDA) signal, an audio mute signal (“MUTE”) (e.g., on the receiver side), and/or any other suitable control signal, e.g., as described below.

Although embodiments of the invention are not limited in this respect, in some demonstrative embodiments video data 112 may correspond to any suitable format of video data. In one example, video data 112 may include HDTV video data, for example, uncompressed HDTV data.

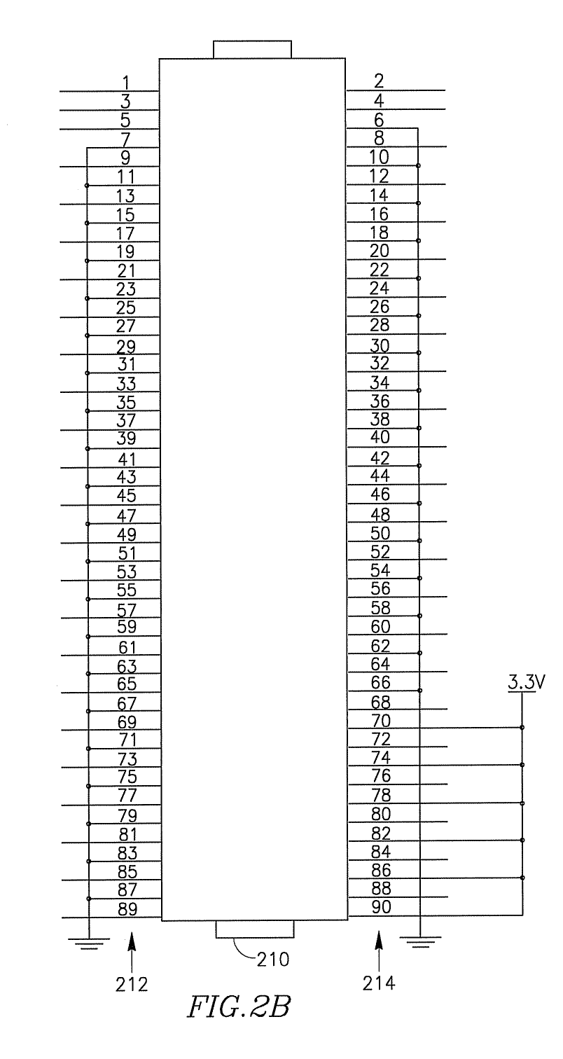

In some embodiments, video source 102 may include a converter 193 to convert signals of one or more suitable video and/or audio formats into the digital-video bits of video data 112, synchronization signals 113, clock signals 114, and/or audio signals 115, e.g., as described below with reference to FIG. 3. For example, converter 193 may generate the digital-video bits of video data 112, synchronization signals 113, clock signals 114, and/or audio signals 115 based on video signals of a Digital Video Interface (DVI) format, a High Definition Multimedia Interface (HDMI) format, a Video Graphics Array (VGA) format, a VGA DB-15 format, an Extended Graphics Array (XGA) format, any extension of the above formats, and/or any other suitable video format. Additionally or alternatively, converter 193 may generate signals 115, for example, based on audio signals of a SPDIF audio signal, an analog stereo audio signal, an I²S signal, and/or any other suitable analog and/or digital audio signal. In one example, converter 193 may be implemented as part of video generator 110. In another example, video generator 110 and converter 193 may be implemented as separate devices, units or modules. In another example, converter 193 and interface 130 may be implemented as part of a common device or unit, which may include a plurality of inputs to be connected to video generator 110 and/or one or more audio sources, for example, using one or more suitable lines or cables, e.g., as described below.

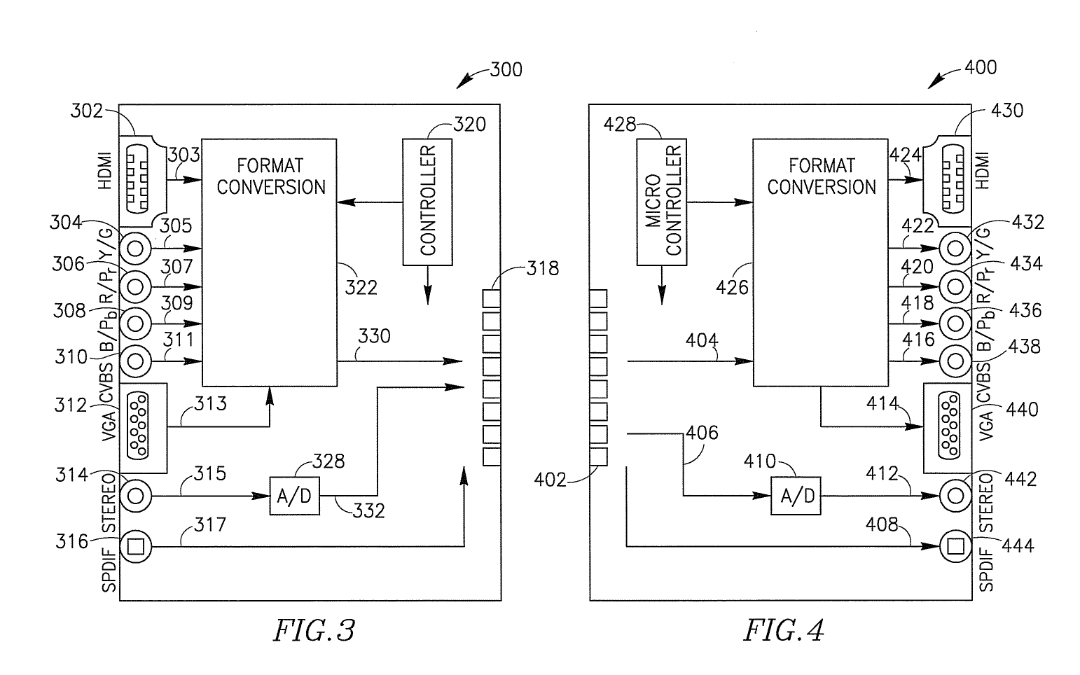

In some embodiments, video destination 108 may include a converter 197 to convert signals 160, 161, 162 and/or 163 into signals of one or more suitable video and/or audio formats, e.g., as described below with reference to FIG. 4. For example, converter 197 may convert digital-video bits 160, synchronization signals 161, clock signals 162, and/or audio signals 163 into video signals of a DVI format, a HDMI format, a VGA format, a VGA DB-15 format, an XGA format, any extension of the above formats, and/or any other suitable video format. Additionally or alternatively, converter 197 may convert audio signals 163, for example, into audio signals of a SPDIF audio signal, an analog stereo audio signal, and/or any other suitable analog and/or digital audio signal. In one example, converter 197 may be implemented as part of display 196. In another example, display 196 and converter 197 may be implemented as separate devices, units or modules. In another example, converter 197 and interface 178 may be implemented as part of a common device or unit, which may include a plurality of outputs to be connected to display 196 and/or one or more audio destinations, e.g., using one or more suitable lines or cables.

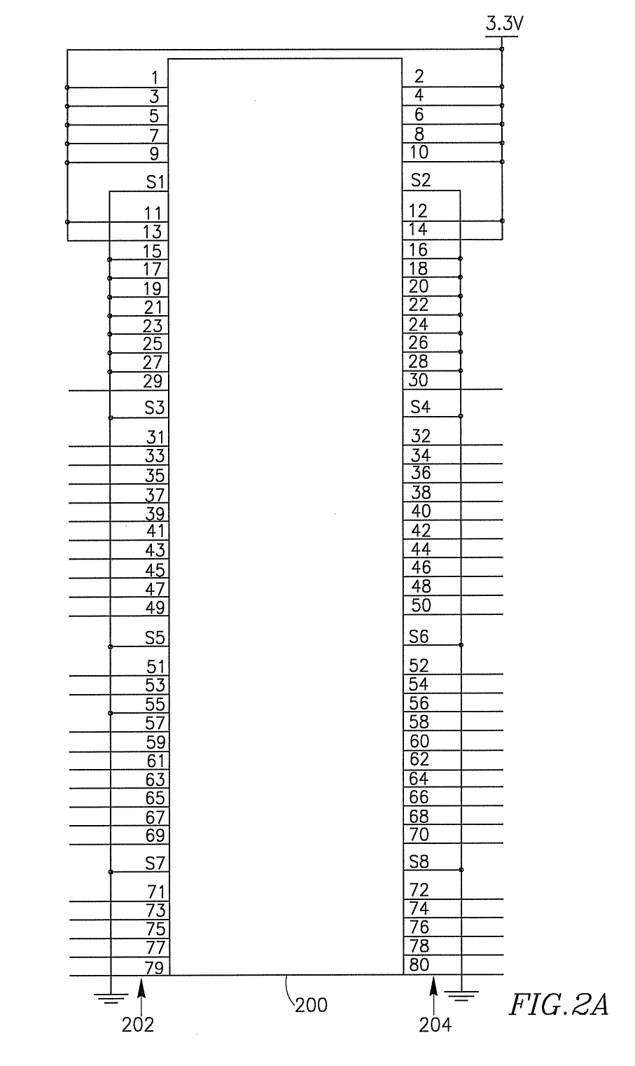

In one example, at least one of interfaces 130, 132, 176 and/or 178 may include a shielded interface including a plurality of power connectors, for example, a plurality of power-voltage connectors and/or a plurality of power-ground connectors, grouped together at a first section of the interface, e.g., at an end of the interface; a plurality of control connectors grouped together at a second section of the interface, e.g., adjacent to the first section; a plurality of video-data, synchronization and/or clock connectors grouped together at a third section of the interface, e.g., adjacent to the second section; and/or a plurality of audio connectors grouped together at a fourth section of the interface, e.g., adjacent to the third section, for example as described below with reference to FIG. 2A. Additionally or alternatively, the shielded interface may include a DCLK connection adjacent to a ground connection, e.g., as described below with reference to FIG. 2A.

In another example, at least one of interfaces 130, 132, 176 and/or 178 may include an unshielded interface including a plurality of control connectors grouped together at a first section of the interface, e.g., at an end of the interface; a plurality of video-data and/or synchronization connectors grouped together at a second section of the interface, e.g., adjacent to the first section; a plurality of audio connectors grouped together at a third section of the interface, e.g., adjacent to the second section; and/or a plurality of power connectors interleaved between the video-data, synchronization, clock, and/or audio connectors, for example as described below with reference to FIG. 2B. For example, a plurality of power-voltage connectors (pins) may be grouped together and interleaved with the video-data, synchronization, clock, and/or audio connectors (pins); and/or one or more of the control, audio and/or video-data connectors (pins), e.g., each of the control, audio and/or video-data connectors (pins), may be adjacent to a respective ground connector (pins), e.g., as described below with reference to FIG. 2B.

Reference is now made to FIG. 2A, which schematically illustrates a shielded digital interface 200 in accordance with some demonstrative embodiments. Although embodiments of the invention are not limited in this respect, in some demonstrative embodiments digital interface 200 may be implemented by at least one of digital-output interface 130 (FIG. 1), digital-input interface 132 (FIG. 1), digital-output interface 176 (FIG. 1), and digital-input interface 178 (FIG. 1).

In some demonstrative embodiments, interface 200 may be implemented as an electrical connector having eighty electrical connections (pins), denoted 1 . . . 80. In one example, interface 200 may be implemented as a male electrical connector having eighty connector pins. In another example, interface 200 may be implemented as a female electrical connector having eighty receptacle contacts or contact holes.

In some demonstrative embodiments, the eighty electrical connectors (pins) of interface 200 may be arranged in an odd-even order including a first connector column 202, e.g., including the odd electrical connectors (pins) 1, 3, 5, 7 . . . , 79; and a second connector column 204, e.g., including the even electrical connectors (pins) 2, 4, 6, 8 . . . , 80. In other embodiments, the electrical connectors (pins) of interface 200 may be arranged in any other suitable manner, e.g., in any other suitable number of columns including equal or different numbers of connectors (pins).

In some demonstrative embodiments, the electrical connectors (pins) of interface 200 may include one or more power connectors (pins) to transfer electric power. In one example, interface 200 may include a plurality of power connectors (pins) grouped together at a first section, e.g., at a first end of interface 200. For example, interface 200 may include power-voltage connectors (pins) 1, 2, 3, 4, 5, 6, 7, 8, 9, 10, 11, 12, 13, and 14 to be connected to at least one voltage source, e.g., a voltage of 3.3 Volts (V) and/or a voltage of 5V; and a plurality of power-ground connectors (pins), e.g., connectors (pins) 15, 16, 17, 18, 19, 20, 21, 22, 23, 24, 25, 26, 27, and/or 28, to be connected to ground.

In some demonstrative embodiments, grouping the power connectors (pins), e.g., the power-voltage and power-ground connectors (pins), of shielded interface 200, e.g., at the first end of shielded interface 200, may cause a return current of the power connectors (pins) to pass through the first end of interface 200 without, for example, substantially passing through other sections of shielded interface 200.

In some demonstrative embodiments, the electrical connectors (pins) of interface 200 may include one or more control connectors (pins) to transfer one or more control signals, respectively. The control connectors (pins) may be grouped together at a second section of interface 200, e.g., adjacent to the first section. In one example, interface 200 may include connectors (pins) 33, 34, 35, 36 and/or 38 to input/output a video RESET signal, a SCL signal, a video INT signal, a SDA signal, and/or an audio MUTE signal, respectively.

In some demonstrative embodiments, the electrical connectors (pins) of interface 200 may include a plurality of video-data connectors (pins) to transfer a respective plurality of digital-video bits representing a pixel of a video, and one or more synchronization connectors (pins) to transfer one or more respective synchronization signals corresponding to the video image. The video-data connectors (pins) may be grouped together at a third section of interface 200, e.g., adjacent to the second section. In one example, interface 200 may include thirty connectors (pins), e.g., connectors (pins) 39, 40, 41, 42, 43, 44, 45, 46, 47, 48, 49, 50, 51, 52, 53, 54, 56, 58, 60, 61, 62, 63, 64, 65, 66, 67, 68, 69, 70, and 71, to input/output thirty respective digital-video bits; and/or three synchronization connectors (pins), e.g., connectors (pins) 72, 73, and 74, to input/output three synchronization signals, e.g., as described below.

In some demonstrative embodiments, the electrical connectors (pins) of interface 200 may include at least one clock connector (pin) to transfer a clock signal corresponding to the video image. In one example, interface 200 may include a connector (pin), e.g., connector (pin) 57, to input/output a clock signal, e.g., a DCLK signal as described below.

In some embodiments, the electrical connectors (pins) of interface 200 may include at least one ground connector (pin), e.g., connector (pin) 55 and/or connector (pin) 59, adjacent to DCLK connector (pin) 57, in order, for example, to prevent a return current of the DCLK signal, which may be relatively “noisy” and/or periodic, from passing through other sections of shielded interface 200.

In some demonstrative embodiments, the electrical connectors (pins) of interface 200 may include at least one audio connector (pin) to transfer an audio signal. For example, one or more audio connectors (pins) may be grouped together at a fourth section of interface 200, e.g., adjacent to the third section. In one example, interface 200 may include three connectors (pins), e.g., connectors (pins) 76, 79, and 80, to input/output a SPDIF audio signal, a LRCLK and a SCLK signal, respectively, e.g., as described below.

In one example, the electrical connectors (pins) of interface 200 may include one or more connectors (pins), e.g., one or more of connectors (pins) 29, 30, 31, 37, 38 and/or 75, assigned for General Purpose Input/Output (GPIO). In another example, one or more connectors (pins) of interface 200, e.g., connector (pin) 30, may be assigned to a serial communication transmission signal, e.g., a Universal Asynchronous Receiver-Transmitter (UART) Tx signal; and/or one or more connectors (pins) of interface 200, e.g., connector (pin) 32, may be assigned to a serial communication reception signal, e.g., a UART Rx signal. In another example, connectors (pins) 29 and/or 31 may be connected to ground. In another example, a connector (pin) of interface 200, e.g., connector (pin) 75, may be assigned to an audio master clock (MCLK). In another example, one or more connectors (pins) of interface 200, e.g., one or more of connectors (pins) 29, 30, 31, 32, 37, 38, 59 and/or 75 may remain not connected (NC). In another example, one or more connectors of interface 200, e.g., connectors (pins) 77 and/or 78, may include I²S connectors (pins).

In one demonstrative embodiment, the connectors (pins) of interface 200 may input/output the following signals, wherein D0, D1 . . . D29 denote the thirty digital-video bits, respectively:

TABLE 1

| Connector | | Connector | |
|---|---|---|---|
| number | Signal | number | Signal |
| 1 | 3.3 V | 2 | 3.3 V |
| 3 | 3.3 V | 4 | 3.3 V |
| 5 | 3.3 V | 6 | 3.3 V |
| 7 | 3.3 V | 8 | 3.3 V |
| 9 | 3.3 V | 10 | 3.3 V |
| 11 | 3.3 V | 12 | 3.3 V |
| 13 | 3.3 V | 14 | 3.3 V |
| 15 | GND | 16 | GND |
| 17 | GND | 18 | GND |
| 19 | GND | 20 | GND |
| 21 | GND | 22 | GND |
| 23 | GND | 24 | GND |
| 25 | GND | 26 | GND |
| 27 | GND | 28 | GND |
| 29 | GND/GPIO1/NC | 30 | UART2_TX/GPIO2/NC |
| 31 | GND/GPIO3/NC | 32 | UART2_RX/GPIO4/NC |
| 33 | WHDI_RESET_{—} | 34 | WHDI_SCL |
| 35 | WHDI_INT | 36 | WHDI_SDA |
| 37 | NC/GPIO5 | 38 | WHDI_MUTE/NC/ |
| | | | GPIO6 |
| 39 | WHDI_D28 | 40 | WHDI_D29 |
| 41 | WHDI_D26 | 42 | WHDI_D27 |
| 43 | WHDI_D24 | 44 | WHDI_D25 |
| 45 | WHDI_D22 | 46 | WHDI_D23 |
| 47 | WHDI_D20 | 48 | WHDI_D21 |
| 49 | WHDI_D18 | 50 | WHDI_D19 |
| 51 | WHDI_D16 | 52 | WHDI_D17 |
| 53 | WHDI_D14 | 54 | WHDI_D15 |
| 55 | GND | 56 | WHDI_D13 |
| 57 | WHDI_DCLK | 58 | WHDI_D11 |
| 59 | GND/NC | 60 | WHDI_D9 |
| 61 | WHDI_D12 | 62 | WHDI_D7 |
| 63 | WHDI_D10 | 64 | WHDI_D5 |
| 65 | WHDI_D8 | 66 | WHDI_D3 |
| 67 | WHDI_D6 | 68 | WHDI_D1 |
| 69 | WHDI_D4 | 70 | WHDI_D0 |
| 71 | WHDI_D2 | 72 | WHDI_DE |
| 73 | WHDI_H_SYNC | 74 | WHDI_V_SYNC |
| 75 | WHDI_MCLK/NC/ | 76 | WHDI_SPDIF |
| | GPIO7 | | |
| 77 | WHDI_I2S_D1 | 78 | WHDI_I2S_D0 |
| 79 | WHDI_LRCLK | 80 | WHDI_SCLK |

In other embodiments, any other suitable arrangement and/or configuration for the connectors (pins) of interface 200 may be implemented.

Reference is now made to FIG. 2B, which schematically illustrates an unshielded digital interface 210 in accordance with some demonstrative embodiments. Although embodiments of the invention are not limited in this respect, in some demonstrative embodiments digital interface 210 may be implemented by at least one of digital-output interface 130 (FIG. 1), digital-input interface 132 (FIG. 1), digital-output interface 176 (FIG. 1), and digital-input interface 178 (FIG. 1).

In some demonstrative embodiments, interface 210 may be implemented as an electrical connector having ninety electrical connections (pins), denoted 1 . . . 90. In one example, interface 210 may be implemented as a male electrical connector having ninety connector pins. In another example, interface 210 may be implemented as a female electrical connector having ninety receptacle contacts or contact holes.

In some demonstrative embodiments, the ninety electrical connectors (pins) of interface 210 may be arranged in an odd-even order including a first connector (pins) column 212, e.g., including the odd electrical connectors (pins) 1, 3, 5, 7 . . . , 89; and a second connector (pins) column 214, e.g., including the even electrical connectors (pins) 2, 4, 6, 8 . . . , 90. In other embodiments, the electrical connectors (pins) of interface 210 may be arranged in any other suitable manner, e.g., in any other suitable number of columns including equal or different numbers of connectors (pins).

In some demonstrative embodiments, the electrical connectors (pins) of interface 210 may include one or more control connectors (pins) to transfer one or more control signals, respectively. The control connectors (pins) may be grouped together at a first section of interface 210, e.g., at a first end of interface 210. In one example, interface 210 may include connectors (pins) 1, 4, 5, 8 and/or 12 to input/output a SCL signal, an audio MUTE signal, a SDA signal, a video RESET signal, and a SCL signal, respectively.

In some demonstrative embodiments, the electrical connectors (pins) of interface 210 may include a plurality of video-data connectors (pins) to transfer a respective plurality of digital-video bits representing a pixel of a video, and one or more synchronization connectors (pins) to transfer one or more respective synchronization signals corresponding to the video image. The video-data connectors (pins) may be grouped together at a second section of interface 210, e.g., adjacent to the first section. In one example, interface 210 may include thirty connectors (pins), e.g., connectors (pins) 9, 13, 16, 17, 20, 21, 24, 25, 28, 29, 32, 33, 36, 37, 40, 41, 44, 45, 49, 52, 53, 56, 57, 60, 61, 64, 65, 68, 69, and/or 72, to input/output thirty respective digital-video bits; and/or three synchronization connectors (pins), e.g., connectors (pins) 73, 76, and 77, to input/output three synchronization signals, e.g., as described below.

In some demonstrative embodiments, the electrical connectors (pins) of interface 210 may include at least one clock connector (pins) to transfer a clock signal corresponding to the video image. In one example, interface 210 may include a connector (pin), e.g., connector 48, to input/output a clock signal, e.g., a DCLK signal as described below.

In some demonstrative embodiments, the electrical connectors (pins) of interface 210 may include at least one audio connector (pin) to transfer an audio signal. For example, one or more audio connectors (pins) may be grouped together at a third section of interface 210, e.g., adjacent to the second section. In one example, interface 210 may include three connectors (pins), e.g., connectors (pins) 81, 88, and 89, to input/output a SPDIF audio signal, a LRCLK signal and a SCLK signal, respectively, e.g., as described below.

In some demonstrative embodiments, the electrical connectors (pins) of interface 210 may include one or more power connectors (pins) to transfer electric power. In one example, interface 210 may include a plurality of power connectors (pins) interleaved between the video-data, synchronization, clock, and/or audio connectors (pins). For example, interface 210 may include a plurality of power-voltage connectors (pins) grouped together and interleaved with the video-data, synchronization, clock, and/or audio connectors (pins); and/or a plurality of ground connectors (pins) interleaving between the video-data, synchronization, clock, and/or audio connectors (pins). For example, interface 210 may include power-voltage connectors (pins) 70, 74, 78, 82, 86 and/or 90 to be connected to at least one voltage source, e.g., a voltage of 3.3V and/or a voltage of 5V; and a plurality of power-ground connectors (pins), e.g., connectors (pins) 6, 7, 10, 11, 14, 15, 18, 19, 22, 23, 26, 27, 30, 31, 34, 35, 38, 39, 42, 43, 46, 47, 50, 51, 54, 55, 58, 59, 62, 63, 66, 67, 71, 75, 79, 83, and/or 87, to be connected to ground.

In some demonstrative embodiments, the separation between video-data, synchronization, clock, and/or audio connectors (pins) by the power-voltage and/or ground connectors (pins) may reduce and/or prevent signal interference between the signals passing through each two adjacent video-data (preventing cross talk), synchronization, clock, and/or audio connectors (pins) of unshielded interface 210.

In one example, the electrical connectors (pins) of interface 210 may include one or more connectors (pins), e.g., connectors (pins) 2 and/or 3, assigned for GPIO. In another example, connectors (pins) 2 and/or 3 may be connected to ground. In another example, a connector (pin) of interface 210, e.g., connector (pin) 80, may be assigned to an audio MCLK signal. In another example, one or more connectors (pins) of interface 210, e.g., connectors (pins) 4 and/or 80, may remain not connected (NC).

In one demonstrative embodiment, the connectors (pins) of interface 210 may input/output the following signals:

TABLE 2

| Connector | | Connector | |
|---|---|---|---|
| number | Signal | number | Signal |
| 1 | WHDI_SCL | 2 | WHDI_GPIO1/GND |
| 3 | WHDI_GPIO2/GND | 4 | WHDI_MUTE/NC |
| 5 | WHDI_SDA | 6 | GND |
| 7 | GND | 8 | WHDI_RESET_{—} |
| 9 | WHDI_D29 | 10 | GND |
| 11 | GND | 12 | WHDI_INT |
| 13 | WHDI_D27 | 14 | GND |
| 15 | GND | 16 | WHDI_D28 |
| 17 | WHDI_D25 | 18 | GND |
| 19 | GND | 20 | WHDI_D26 |
| 21 | WHDI_D23 | 22 | GND |
| 23 | GND | 24 | WHDI_D24 |
| 25 | WHDI_D21 | 26 | GND |
| 27 | GND | 28 | WHDI_D22 |
| 29 | WHDI_D19 | 30 | GND |
| 31 | GND | 32 | WHDI_D20 |
| 33 | WHD_D17 | 34 | GND |
| 35 | GND | 36 | WHDI_D18 |
| 37 | WHDI_D15 | 38 | GND |
| 39 | GND | 40 | WHDI_D16 |
| 41 | WHDI_D13 | 42 | GND |
| 43 | GND | 44 | WHDI_D14 |
| 45 | WHDI_D11 | 46 | GND |
| 47 | GND | 48 | WHDI_DCLK |
| 49 | WHDI_D9 | 50 | GND |
| 51 | GND | 52 | WHDI_D12 |
| 53 | WHDI_D7 | 54 | GND |
| 55 | GND | 56 | WHDI_D10 |
| 57 | WHDI_D5 | 58 | GND |
| 59 | GND | 60 | WHDI_D8 |
| 61 | WHDI_D3 | 62 | GND |
| 63 | GND | 64 | WHDI_D6 |
| 65 | WHDI_D1 | 66 | GND |
| 67 | GND | 68 | WHDI_D4 |
| 69 | WHDI_D0 | 70 | 3.3 V |
| 71 | GND | 72 | WHDI_D2 |
| 73 | WHDI_DE | 74 | 3.3 V |
| 75 | GND | 76 | WHDI_H_SYNC |
| 77 | WHDI_V_SYNC | 78 | 3.3 V |
| 79 | GND | 80 | WHDI_MCLK/NC |
| 81 | WHDI_SPDIF | 82 | 3.3 V |
| 83 | GND | 84 | WHDI_I2S_D1 |
| 85 | WHDI_I2S_D0 | 86 | 3.3 V |
| 87 | GND | 88 | WHDI_LRCLK |
| 89 | WHDI_SCLK | 90 | 3.3 V |

Reference is now made to FIG. 3, which schematically illustrates a video source converter 300 in accordance with some demonstrative embodiments. Although embodiments of the invention are not limited in this respect, in some demonstrative embodiments converter 300 may perform the functionality of converter 193 (FIG. 1).

In some demonstrative embodiments, converter 300 may include at least one of an HDMI input 302 to receive an HDMI input signal 303; a plurality of component video inputs, e.g., a Y/G input 304 to receive a Y/G input signal 305, a R/Pr input 306 to receive a R/Pr input signal 307, and a B/Pb input 308 to receive a B/Pb input signal 309; a composite video input, e.g., a Composite Video Blanking and Sync (CVBS) input 310 to receive a CVBS input signal 311; a VGA input 312 to receive a VGA input signal 313; a stereo input 314 to receive an analog stereo input signal 315; a SPDIF input 316 to receive a SPDIF input signal 317; and/or any other suitable input to receive a video and/or audio signals of any suitable format.

In some demonstrative embodiments, converter 300 may include or may be connected to a digital-output interface 318. For example, interface 318 may perform the functionality of interface 130 (FIG. 1).

In some demonstrative embodiments, converter 300 may also include a format conversion module 322, e.g., any suitable display processor and/or format converter, to convert signals 303, 305, 307, 309, and/or 311 into signals 330 in a format suitable for interface 318. Signals 330 may include, for example, digital-video bits representing a pixel of a video image of signals 303, 305, 307, 309 and/or 311; and/or one or more synchronization signals corresponding to the video image of signals 303, 305, 307, 309 and/or 311. For example, signals 330 may include video data signals 112 (FIG. 1), and/or synchronization signals 113 (FIG. 1). Converter 320 may also include a controller 320 to control conversion module 322, e.g., based on a number of rows and/or columns of the video data signals, and/or to monitor, for example, exchange of encryption keys pass Extended Display Identification Data (EDID) and/or pass messages between the source and destination.

In some demonstrative embodiments, converter 300 may also include an analog to digital (A/D) audio converter 328 to convert analog audio signals 315 into digital signals 332, e.g., in an I2S format or a SPDIF format, to be provided to interface 318. For example, signals 115 (FIG. 1) may include signals 332 and/or 317.

Reference is now made to FIG. 4, which schematically illustrates a video destination converter 400 in accordance with some demonstrative embodiments. Although embodiments of the invention are not limited in this respect, in some demonstrative embodiments converter 400 may perform the functionality of converter 197 (FIG. 1).

In some demonstrative embodiments, converter 400 may include or may be connected to a digital-input interface 402 to receive signals 404 including digital-video bits representing a pixel of a video image of a received wireless transmission, and one or more synchronization signals corresponding to the video image. For example, interface 402 may perform the functionality of interface 178 (FIG. 1). Interface 402 may also receive one or more digital audio signals, e.g., signals 406 and/or 408, corresponding to the received transmission. For example, signals 406 and/or 408 may be part of signals 163 (FIG. 1). In one example, signals 406 may include stereo digital audio signals, e.g., corresponding to signals 332 (FIG. 3); and/or signals 408 may include SPDIF signals, e.g., corresponding to SPDIF signals 317 (FIG. 3).

In some demonstrative embodiments, converter 400 may also include a format conversion module 426 to convert signals 404 into signals of one or more suitable video and/or audio formats. For example, format conversion module 426 may convert signals 404 into one or more of an HDMI signal 424; a plurality of component video signals, e.g., a Y/G signal 422, a R/Pr signal 420, and a B/Pb signal 418; a composite video signal, e.g., a CVBS signal 416; and/or a VGA signal 414. Converter 400 may also include a controller 428 to control conversion module 426, for example, to monitor exchange of encryption keys pass EDID and/or pass messages between the source and destination.

In some demonstrative embodiments, converter 400 may also include a digital to analog (D/A) converter 410 to convert digital signals 406 into analog signals 412.

In some demonstrative embodiments, converter 400 may include at least one of an HDMI output 430 to output HDMI signal 424; a plurality of component video outputs, e.g., a Y/G output 432 to output Y/G signal 422, a R/Pr output 434 to output R/Pr signal 420, and a B/Pb output 436 to output B/Pb signal 418; a composite video output, e.g., a CVBS output 438 to output CVBS signal 416; a VGA output 440 to output VGA signal 414; a stereo output 442 to output analog stereo signal 412; a SPDIF output 444 to output SPDIF signal 444; and/or any other suitable output to output a video and/or audio signals of any suitable format.

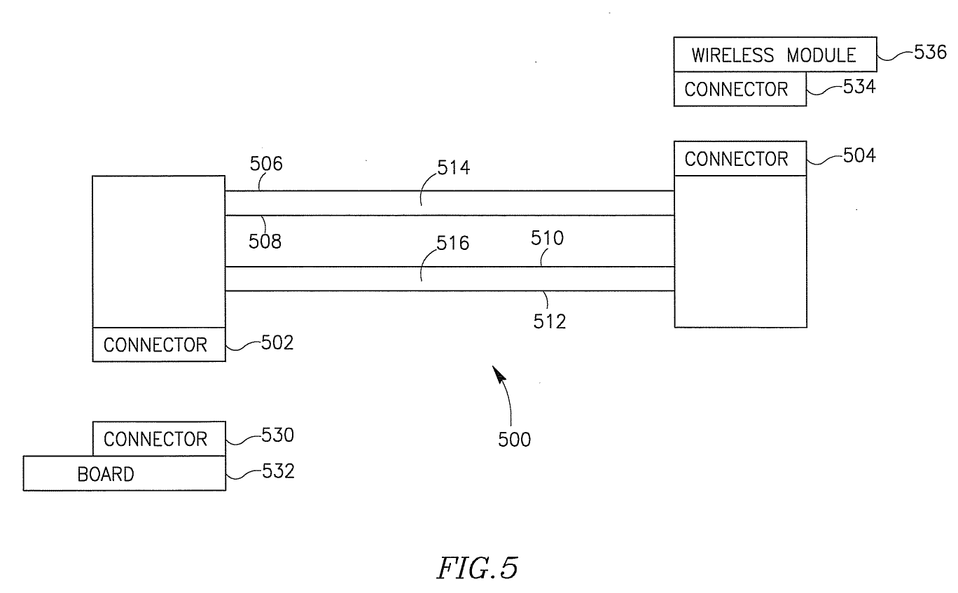

Reference is now made to FIG. 5, which schematically illustrates a connector assembly 500 in accordance with some demonstrative embodiments. In some non-limiting embodiments, connector assembly 500 may be implemented to connect between a board 532 and a wireless module 536. In one example, board 532 may include a board of a video source, e.g., video source 102 (FIG. 1), and wireless module 536 may include a transmitter, e.g., transmitter 104 (FIG. 1), which may be distant from board 532. In another example, board 532 may include a board of a video destination, e.g., video destination 108, and wireless module 536 may include a receiver, e.g., receiver 106 (FIG. 1), which may be distant from board 532. In some demonstrative embodiments, board 532 may include or may be connected to a connector interface 530, e.g., interface 130 (FIG. 1) or interface 178 (FIG. 1). Wireless module 536 may be connected to a connector interface 534, e.g., interface 132 (FIG. 1) or interface 176 (FIG. 1).

In some demonstrative embodiments, connector assembly 500 may include a first connector interface 502 coupled to a second connector interface 504 via a pair of flex cables 514 and 516. Connector interface 502 may include, for example, interface 132 (FIG. 1) or interface 176 (FIG. 1).

In some demonstrative embodiments, flex cable 514 may include a signal layer 506 and a ground layer 508; and flex cable 516 may include a signal layer 510 and a ground layer 512. Flex cables 514 and 516 may be arranged such that ground layer 508 faces signal layer 510. In one example, signal layers 506 and 510 may connect between connectors of interface 502 and connectors of interface 504.

In some embodiments, flex cables 514 and 516 may have any desired, required, and/or suitable length. For example, flex cables 514 and 516 may have a length of at least five centimeters, for example, at least ten centimeters, e.g., at least twenty centimeters. In one non-limiting example, flex cables 514 and 516 may have a length of approximately 22 centimeters.

In some embodiments, connector assembly 500 may be implemented to connect between board 532 and wireless module 536 to enable placing wireless module 536 at a desired, required, and/or suitable distance, for example, a distance longer than five centimeters, e.g., a distance longer than ten centimeters, from board 532, e.g., from a video destination or video source of board 532.

In some embodiments, connector assembly 500 may be implemented to connect between board 532 and wireless module 536 to enable placing wireless module 536 at a desired, required and/or suitable position, orientation and/or angle relative to board 532, e.g., relative to a video destination or video source of board 532.

Some embodiments may be implemented by software, by hardware, or by any combination of software and/or hardware as may be suitable for specific applications or in accordance with specific design requirements. Some embodiments may include units and sub-units, which may be separate of each other or combined together, in whole or in part, and may be implemented using specific, multi-purpose or general processors, or devices as are known in the art. Some embodiments may include buffers, registers, storage units and/or memory units, for temporary or long-term storage of data and/or in order to facilitate the operation of a specific embodiment.

While certain features have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. A wireless video transmitter to transmit a wireless video transmission representing a video image, the transmitter comprising:
a digital-input interface including a plurality of video-data inputs to receive a respective plurality of digital-video bits representing a pixel of said video image, and one or more synchronization inputs to receive one or more respective synchronization signals corresponding to said video image; and
a transmitter module to transmit said wireless video transmission based on said plurality of digital-video bits and said synchronization signals.

2. The wireless video transmitter of claim 1, wherein said input interface includes one or more power inputs to receive electric power to power said transmitter module.

3. The wireless video transmitter of claim 2, wherein said input interface comprises a shielded input interface, wherein said one or more power inputs comprise a plurality of power-voltage inputs grouped together at a first section of said input interface, and wherein said plurality of video-data inputs are grouped together at a second section of said input interface.

4. The wireless video transmitter of claim 2, wherein said input interface comprises an unshielded input interface, wherein said plurality of video-data inputs are grouped together at a section of said input interface, and wherein adjacent video-data inputs are separated from one another by a ground connector or a power-voltage connector.

5. The wireless video transmitter of claim 1, wherein said plurality of video-data inputs comprise at least thirty video-data inputs to receive at least thirty respective digital-video bits representing a pixel of said video image.

6. The wireless video transmitter of claim 1, wherein said one or more synchronization inputs comprise at least one of a data-enable input to receive a data-enable signal corresponding to said video image, a horizontal-synchronization input to receive a horizontal-synchronization signal corresponding to said video image, and a vertical-synchronization input to receive a vertical-synchronization signal corresponding to said video image.

7. The wireless video transmitter of claim 1, wherein said input interface comprises at least one clock input to receive a clock signal corresponding to said video image.

8. The wireless video transmitter of claim 7, comprising at least one ground connector adjacent to said clock input.

9. The wireless video transmitter of claim 7, wherein said at least one clock input comprises a data-clock input to receive a data-clock signal.

10. The wireless video transmitter of claim 1, wherein said input interface includes one or more audio inputs to receive one or more digital audio signals.

11. A video source comprising:
a video generator to generate video data to be displayed; and
a digital-output interface including a plurality of video-data outputs to provide a respective plurality of digital-video bits representing a pixel of a video image of said video data, and one or more synchronization outputs to output one or more respective synchronization signals corresponding to said video image.

12. The video source of claim 11, wherein said output interface includes one or more power outputs to output electric power to power a transmitter module.

13. The video source of claim 12, wherein said output interface comprises a shielded output interface, wherein said one or more power outputs comprise a plurality of power-voltage outputs grouped together at a first section of said output interface, and wherein said plurality of video-data outputs are grouped together at a second section of said output interface.

14. The video source of claim 12, wherein said output interface comprises an unshielded output interface, wherein said plurality of video-data outputs are grouped together at a section of said output interface, and wherein adjacent video-data inputs are separated from one another by a ground connector or a power-voltage connector.

15. The video source of claim 11, wherein said plurality of video-data outputs comprise at least thirty video-data outputs to provide at least thirty respective digital-video bits representing a pixel of said video image.

16. The video source of claim 11, wherein said one or more synchronization outputs comprise at least one of a data-enable output to output a data-enable signal corresponding to said video image, a horizontal-synchronization output to output a horizontal-synchronization signal corresponding to said video image, and a vertical-synchronization output to output a vertical-synchronization signal corresponding to said video image.

17. The video source of claim 11, wherein said output interface comprises at least one clock output to output a clock signal corresponding to said video image.

18. The video source of claim 17, comprising at least one ground connector adjacent to said clock output.

19. The video source of claim 11, wherein said output interface includes one or more audio outputs to provide one or more digital audio signals.

20. A wireless video receiver to receive a wireless video transmission representing a video image, the wireless video receiver comprising:
a receiver module to receive said wireless video transmission and generate a plurality of digital-video bits representing a pixel of said video image, and to generate one or more synchronization signals corresponding to said video image; and
a digital-output interface including a plurality of video-data outputs to output said plurality of digital-video bits, respectively; and one or more synchronization outputs to output said one or more synchronization signals, respectively.

21. The wireless video receiver of claim 20, wherein said output interface includes one or more power inputs to receive electric power to power said receiver module.

22. The wireless video receiver of claim 21, wherein said output interface comprises a shielded output interface, wherein said one or more power inputs comprise a plurality of power-voltage inputs grouped together at a first section of said output interface, and wherein said plurality of video-data outputs are grouped together at a second section of said output interface.

23. The wireless video transmitter of claim 21, wherein said output interface comprises an unshielded output interface, wherein said plurality of video-data outputs are grouped together at a section of said output interface, and wherein adjacent video-data outputs are separated from one another by a ground connector or a power-voltage connector.

24. The wireless video receiver of claim 20, wherein said plurality of video-data outputs comprise at least thirty video-data outputs to output at least thirty respective digital-video bits representing a pixel of said video image.

25. The wireless video receiver of claim 20, wherein said one or more synchronization outputs comprise at least one of a data-enable output to output a data-enable signal corresponding to said video image, a horizontal-synchronization output to output a horizontal-synchronization signal corresponding to said video image, and a vertical-synchronization output to output a vertical-synchronization signal corresponding to said video image.

26. The wireless video receiver of claim 20, wherein said output interface comprises at least one clock output to output a clock signal corresponding to said video image.

27. The wireless video transmitter of claim 26, comprising at least one ground connector adjacent to said clock output.

28. The wireless video receiver of claim 20, wherein said output interface includes one or more audio outputs to output one or more digital audio signals.

29. A video destination comprising:
a digital-input interface including a plurality of video-data inputs to receive a respective plurality of digital-video bits representing a pixel of a video image, and one or more synchronization inputs to receive one or more respective synchronization signals corresponding to said video image; and
a display to display said video image based on said plurality of digital-video bits.

30. The video destination of claim 29, wherein said input interface includes one or more power outputs to provide electric power to power a receiver module.

31. The video destination of claim 30, wherein said input interface comprises a shielded input interface, wherein said one or more power outputs comprise a plurality of power-voltage outputs grouped together at a first section of said input interface, and wherein said plurality of video-data inputs are grouped together at a second section of said input interface.

32. The video destination of claim 30, wherein said input interface comprises an unshielded input interface, wherein said plurality of video-data inputs are grouped together at a section of said input interface, and wherein adjacent video-data inputs are separated from one another by a ground connector or a power-voltage connector.

33. The video destination of claim 29, wherein said plurality of video-data inputs comprise at least thirty video-data inputs to input at least thirty respective digital-video bits representing a pixel of said video image.

34. The video destination of claim 29, wherein said one or more synchronization inputs comprise at least one of a data-enable input to receive a data-enable signal corresponding to said video image, a horizontal-synchronization input to receive a horizontal-synchronization signal corresponding to said video image, and a vertical-synchronization input to receive a vertical-synchronization signal corresponding to said video image.

35. The video destination of claim 29, wherein said input interface comprises at least one clock input to receive a clock signal corresponding to said video image.

36. The video destination of claim 35, comprising at least one ground connector adjacent to said clock input.

37. The video destination of claim 29, wherein said input interface includes one or more audio inputs to receive one or more digital audio signals.

38. A connector assembly comprising:
a digital-input interface having a plurality of connectors including a plurality of video-data inputs to receive a respective plurality of digital-video bits representing a pixel of a video image, and one or more synchronization inputs to receive one or more respective synchronization signals corresponding to said video image;
a digital-output interface having a plurality of connectors including a plurality of video-data outputs to output said plurality of digital-video bits, respectively; and one or more synchronization outputs to output said one or more synchronization signals, respectively; and
a pair of flex cables to flexibly couple said plurality of video-data inputs to said plurality of video-data outputs, respectively, and to couple said one or more synchronization inputs to said one or more synchronization outputs, respectively.

39. The connector assembly of claim 38, wherein said pair of flex cables comprises:
a first flex cable having a ground layer, and a signal layer to couple a first set of connectors of said digital-input interface to a first set of connectors of said digital-output interface, respectively; and
a second flex cable having a ground layer, and a signal layer to couple a second set of connectors of said digital-input interface to a second set of connectors of said digital-output interface, respectively.

40. The connector assembly of claim 39, wherein the ground layer of said first flex cable faces the signal layer of said second flex cable.

41. The connector assembly of claim 38, wherein said input and output interfaces comprise at least one clock input and output, respectively, to receive and output, respectively, a clock signal corresponding to said video image.

42. The connector assembly of claim 38, wherein said input and output interfaces comprise at least one audio input and output, respectively, to receive and output, respectively, at least one digital audio signal.
